(19) United States
(12) Patent Application Publication
(10) Pub. No.: US 2025/0246841 A1
(43) Pub. Date: Jul. 31, 2025

(54) CONNECTOR

(71) Applicant: SUMITOMO WIRING SYSTEMS, LTD., Mie (JP)

(72) Inventors: Yusuke HASEGAWA, Mie (JP); Yuki KONDO, Mie (JP)

(21) Appl. No.: 19/021,855

(22) Filed: Jan. 15, 2025

(30) Foreign Application Priority Data
Jan. 26, 2024 (JP) 2024-010070

(51) Int. Cl. H01R 13/436

(52) U.S. Cl. CPC H01R 13/4368

(57) ABSTRACT

A connector includes a housing including a cavity extending in a first direction, a terminal and a retainer. The housing is formed with a locking lance resiliently deformable in a second direction orthogonal to the first direction. The retainer includes two lock pieces, a restricting portion and a rib extending from the restricting portion. The restricting portion is disposed at a position deviated in the second direction from the center plane CP. The locking lance interferes with the terminal and is resiliently deformed toward the center plane CP in the second direction in the process of inserting the terminal into the cavity. The two lock pieces interfere with the housing and are resiliently deformed away from the center plane CP in the second direction in the process of moving the retainer from a temporary locking position to a complete locking position.

### CROSS-REFERENCE TO RELATED APPLICATIONS

This application is based on and claims priority from Japanese Patent Application No. 2024-010070, filed on Jan. 26, 2024, with the Japan Patent Office, the disclosure of which is incorporated herein in its entirety by reference.

### TECHNICAL FIELD

The present disclosure relates to a connector.

### BACKGROUND

Conventionally, a connector described in Japanese Patent Laid-open Publication No. 2004-103551 is known. The connector described in patent literature 1 is provided with a female housing, a female terminal to be inserted into a cavity of the female housing and a retainer to be mounted on the front surface of the female housing. With the retainer mounted at a temporary locking position, a plunging portion of the retainer is retracted forward from a deflection space for a locking lance and the resilient deformation of the locking lance is allowed. Thus, the insertion of the female terminal into the cavity is allowed. When the female terminal reaches a proper position in the cavity, the locking lance returns to a natural state and locks the female terminal. If the retainer is pushed from the temporary locking position to a complete locking position, the plunging portion plunges into the deflection space, whereby the resilient deformation of the locking lance is restricted and the female terminal is retained in the cavity.

In the above connector, the retainer may be provided with a front wall, the plunging portion extending rearward from the front wall and a lock piece extending rearward from the front wall and to be locked to the female housing. The female housing may be provided with a temporary locking portion for holding the retainer at the temporary locking position by being locked to the lock piece and a complete locking portion for holding the retainer at the complete locking position by being locked to the lock piece. In the process of moving the retainer from the temporary locking position to the complete locking position, the lock piece is resiliently deformed and rides over the complete locking portion. In the configuration of Japanese Patent Laid-open Publication No. 2004-103551, the locking lance is resiliently deformed in a vertical direction and the lock piece is resiliently deformed in a lateral direction.

### SUMMARY

Unlike Japanese Patent Laid-open Publication No. 2004-103551, if two lock pieces are provided on both upper and lower end parts of a retainer and plunging portions are disposed at positions deviated from a vertical center of the retainer, the plunging portion continuous with the lock piece is possibly deformed in the same direction as the proximate lock piece via a front wall when the lock piece is resiliently deformed. For example, when the plunging portion is located at a position deviated upward from the vertical center of the retainer, the plunging portion is possibly displaced to be inclined upward if the lock piece disposed on an upper end part of the retainer is resiliently deformed upward. Further, when a deflection space for a locking lance, into which space the plunging portion should plunge, is disposed below the locking lance, i.e. when the locking lance is deflected downward when a female terminal is inserted into a cavity, the plunging portion cannot plunge into the deflection space and may interfere with the locking lance if the plunging portion is displaced upward.

The present disclosure was completed on the basis of the above situation and aims to suppress the interference of a retainer and a locking lance when the retainer is moved from a temporary locking position to a complete locking position.

The present disclosure is directed to a connector with a housing including a cavity extending in a first direction, a terminal to be disposed in the cavity and a retainer to be assembled with the housing movably in the first direction between a temporary locking position and a complete locking position, the housing being formed with a locking lance disposed in the cavity and resiliently deformable in a second direction orthogonal to the first direction, the retainer including two lock pieces to be locked to the housing, a restricting portion for allowing insertion of the terminal into the cavity when the retainer is at the temporary locking position and interfering with the locking lance to retain the terminal in the cavity when the retainer is at the complete locking position and a rib extending from the restricting portion, a plane disposed in a center between the two lock pieces in the second direction being a center plane, the restricting portion being disposed at a position deviated in the second direction from the center plane, the locking lance interfering with the terminal and being resiliently deformed toward the center plane in the second direction in the process of inserting the terminal into the cavity, the two lock pieces interfering with the housing and being resiliently deformed away from the center plane in the second direction in the process of moving the retainer from the temporary locking position to the complete locking position, and the rib suppressing the restricting portion from being displaced away from the center plane in the second direction by contacting the housing in the process of moving the retainer from the temporary locking position to the complete locking position.

According to the present disclosure, the interference of a retainer and a locking lance can be suppressed when the retainer is moved from a temporary locking position to a complete locking position.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector according to an embodiment.

FIG. 2 is a back view of a retainer.

FIG. 3 is a perspective view of the retainer.

FIG. 4 is a front view of the connector.

FIG. 5 is a section along A-A of FIG. 4 when the retainer is at a temporary locking position.

FIG. 6 is a section along A-A of FIG. 4 when the retainer is at a complete locking position.

FIG. 7 is a section along B-B of FIG. 4 when the retainer is at the complete locking position.

FIG. 8 is a section along C-C of FIG. 5.

FIG. 9 is a section along D-D of FIG. 6.

FIG. 10 is a perspective view in section along A-A of FIG. 4 with terminals omitted when the retainer is assembled with a housing.

FIG. 11 is a perspective view in section along A-A of FIG. 4 with the terminals omitted when the retainer is at the temporary locking position.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

Embodiments of the present disclosure are first listed and described.
[1] The connector of the present disclosure is provided with a housing including a cavity extending in a first direction, a terminal to be disposed in the cavity and a retainer to be assembled with the housing movably in the first direction between a temporary locking position and a complete locking position, the housing being formed with a locking lance disposed in the cavity and resiliently deformable in a second direction orthogonal to the first direction, the retainer including two lock pieces to be locked to the housing, a restricting portion for allowing insertion of the terminal into the cavity when the retainer is at the temporary locking position and interfering with the locking lance to retain the terminal in the cavity when the retainer is at the complete locking position and a rib extending from the restricting portion, a plane disposed in a center between the two lock pieces in the second direction being a center plane, the restricting portion being disposed at a position deviated in the second direction from the center plane, the locking lance interfering with the terminal and being resiliently deformed toward the center plane in the second direction in the process of inserting the terminal into the cavity, the two lock pieces interfering with the housing and being resiliently deformed away from the center plane in the second direction in the process of moving the retainer from the temporary locking position to the complete locking position, and the rib suppressing the restricting portion from being displaced away from the center plane in the second direction by contacting the housing in the process of moving the retainer from the temporary locking position to the complete locking position.

According to this configuration, even if the lock pieces are resiliently deformed away from the center plane in the second direction in the process of moving the retainer from the temporary locking position to the complete locking position, the rib contacts the housing, whereby the restricting portion can be suppressed from being displaced away from the center plane in the second direction. Thus, the interference of the restricting portion and the locking lance can be avoided and the retainer can be moved to the complete locking position.
[2] In [1] described above, the restricting portions may include a first restricting portion and a second restricting portion disposed on a side opposite to the first restricting portion with respect to the center plane, the ribs may include a first rib extending from the first restricting portion and a second rib extending from the second restricting portion, the cavities may include a first cavity corresponding to the first restricting portion and a second cavity corresponding to the second restricting portion, and the locking lances may include a first locking lance disposed in the first cavity and a second locking lance disposed in the second cavity.
[3] In [1] described above, the rib may be disposed at a position overlapping the locking lance when viewed from the first direction.

According to this configuration, the strength of the rib can be improved while the enlargement of a space for arranging the rib in the housing is avoided.
[4] In [1] described above, the housing may include a recess open toward one side in the first direction and configured to receive the rib, the rib may include a guide portion disposed on an end part on the other side in the first direction, and the guide portion may be inclined to approach the center plane in the second direction toward the other side in the first direction.

According to this configuration, the entrance of the rib into the recess can be guided by the guide portion.
[5] In [1] described above, the housing may include a recess open toward one side in the first direction and configured to receive the rib, the terminal may be inserted into the cavity from the other side in the first direction, the rib may include a first surface constituting the cavity together with the housing and an inclined portion continuous with the first surface and disposed on an end part of the rib on the other side in the first direction, the first surface may be facing the terminal from one side in a third direction orthogonal to both the first and second directions, and the inclined portion may be inclined to be located more on the one side in the third direction toward the other side in the first direction.

According to this configuration, the interference of the rib and the terminal can be suppressed by the inclined portion.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different in each drawing. Further, “orthogonal” in this specification means not only strictly orthogonal, but also substantially orthogonal within a range in which functions and effects in this embodiment are achieved.

### Embodiment

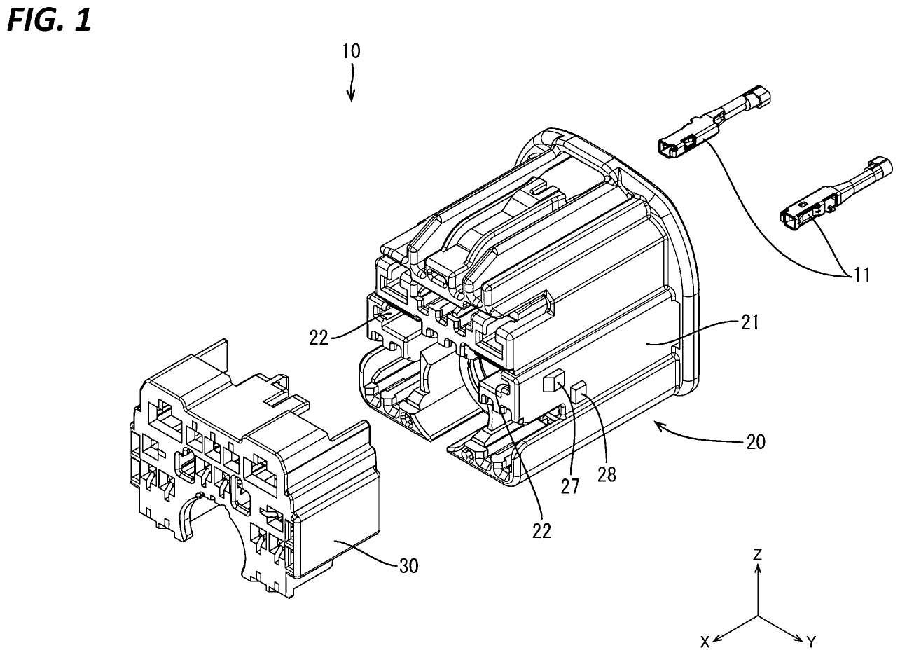

The embodiment of the present disclosure is described with reference to FIGS. 1 to 11. In the following description, a direction indicated by an arrow Z is referred to as an upward direction, a direction indicated by an arrow X is referred to as a forward direction and a direction indicated by an arrow Y is referred to as a leftward direction. In this embodiment, a front-rear direction is an example of a first direction. A lateral direction is an example of a second direction. A vertical direction is an example of a third direction. Note that, for a plurality of identical members, only some members may be denoted by a reference sign and the other members may not be denoted by the reference sign.

### (Connector 10)

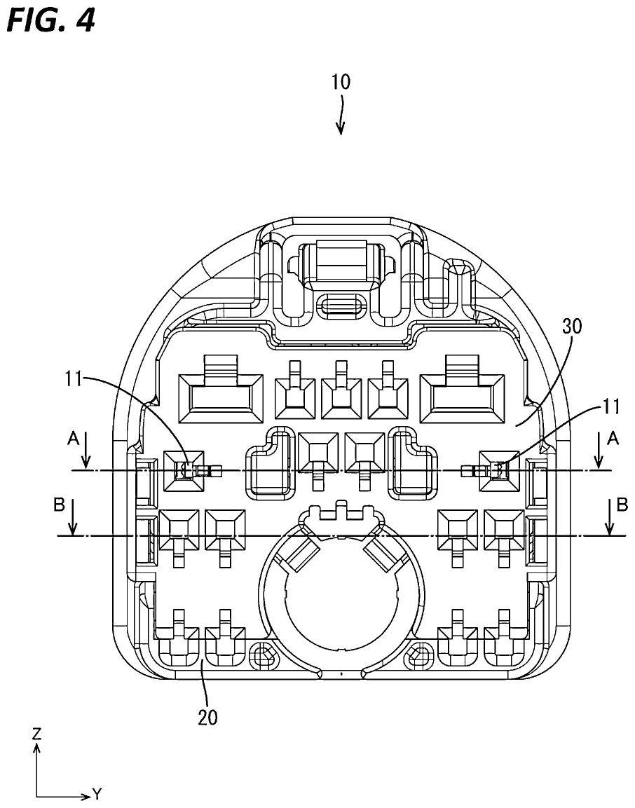

A connector 10 of this embodiment is, as shown in FIGS. 1 and 4, provided with a housing 20, two terminals 11 and a retainer 30.

### (Terminals 11)

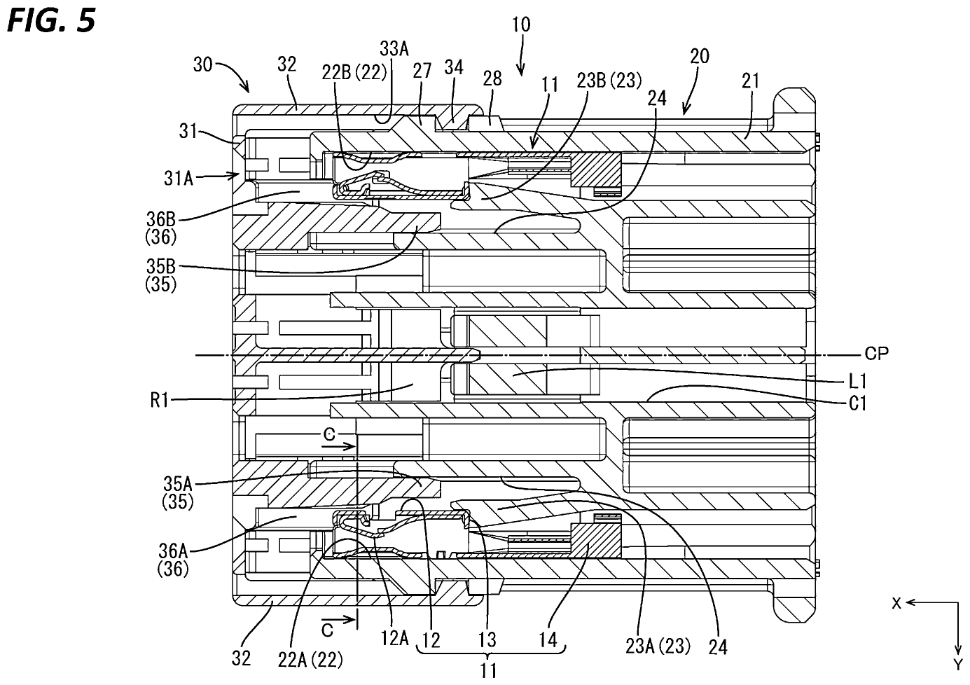

As shown in FIG. 5, the terminal 11 is a female terminal and provided with a connecting tube portion 12, a locking portion 13 and a wire crimping portion 14. The connecting tube portion 12 is, for example, in the form of a rectangular tube. A resilient contact piece 12A is formed inside the connecting tube portion 12. The locking portion 13 is formed on a rear end part of the connecting tube portion 12. The wire crimping portion 14 is connected behind the connecting tube portion 12. Note that the connector 10 may be further provided with terminals different from the terminals 11.

### (Housing 20)

As shown in FIG. 1, the housing 20 includes a substantially block-like housing body 21 and two cavities 22 penetrating through the housing body 21 in the front-rear direction. Further, as shown in FIG. 5, the housing 20 is formed with locking lances 23 disposed in the cavities 22 and resiliently deformable in the lateral direction, and deflection spaces 24, into which the resiliently deformed locking lances 23 can enter. The terminal 11 is inserted into the cavity 22 from behind. In the process of inserting the terminal 11 into the cavity 22, the locking lance 23 interferes with the connecting tube portion 12, is resiliently deformed and enters the deflection space 24. If the terminal 11 is inserted to a proper position in the cavity 22, the locking lance 23 resiliently returns to a natural state and locks the locking portion 13 from behind. In this way, the terminal 11 is suppressed from coming out rearward from the cavity 22. Note that the housing 20 may further include cavities C1 different from the cavities 22 and locking lances L1 disposed in the cavities C1 and different from the locking lances 23 (e.g. locking lances L1 resiliently deformable in the vertical direction).

The two cavities 22 are specifically a first cavity 22A and a second cavity 22B. The first cavity 22A is disposed at a position near a left end part of the housing body 21. The second cavity 22B is disposed at a position near a right end part of the housing body 21. The locking lance 23 disposed in the first cavity 22A is a first locking lance 23A. The locking lance 23 disposed in the second cavity 22B is a second locking lance 23B. With the retainer 30 assembled with the housing 20, the first and second cavities 23A, 23B are arranged on sides opposite to each other in the lateral direction with respect to a center plane CP of the retainer 30 to be described later. The first locking lance 23A is disposed to the left of the center plane CP, and the second locking lance 23B is disposed to the right of the center plane CP.

The deflection space 24 for the first locking lance 23A is disposed to the right of the first locking lance 23A. The first locking lance 23A is resiliently deformed rightward in the process of inserting the terminal 11 into the first cavity 22A. The deflection space 24 for the second locking lance 23B is disposed to the left of the second locking lance 23B. The second locking lance 23B is resiliently deformed leftward in the process of inserting the terminal 11 into the second cavity 22B. That is, the two locking lances 23 are respectively resiliently deformed in directions toward the center plane CP in the process of inserting the terminals 11 into the corresponding cavities 22.

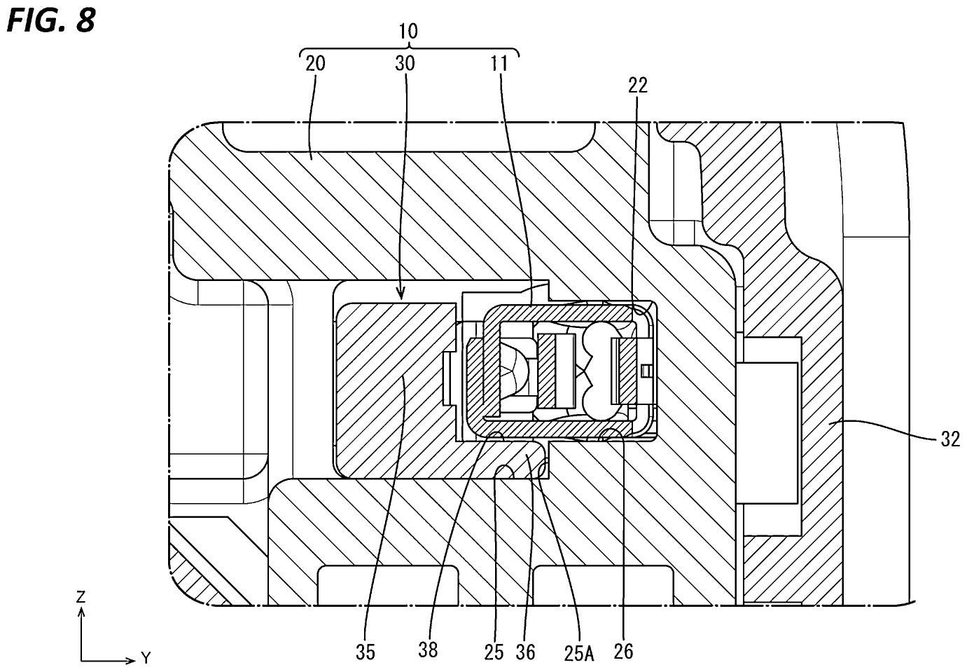

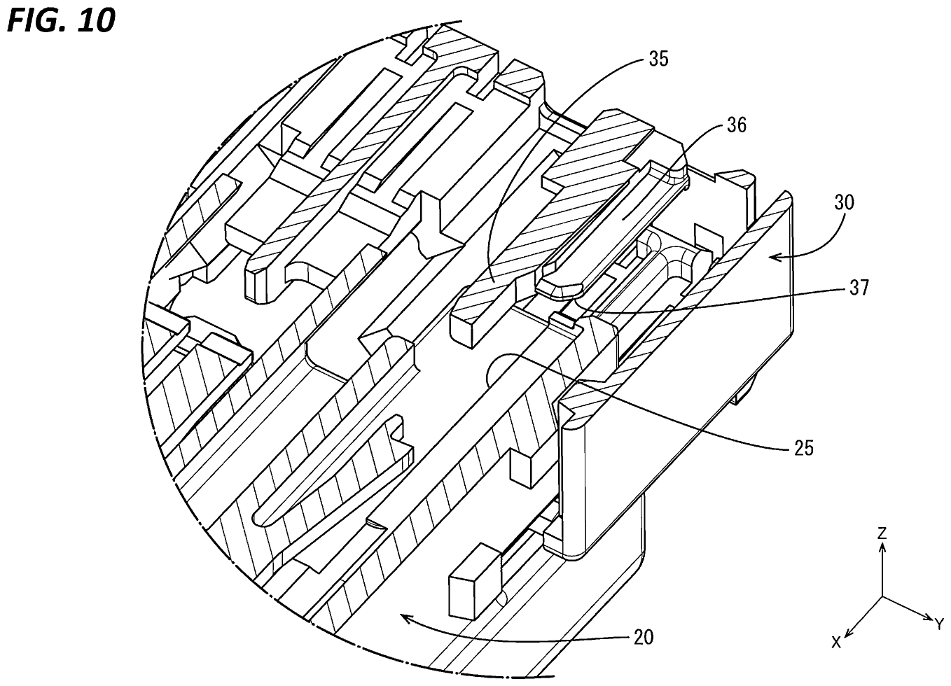

As shown in FIG. 8, the housing 20 is provided with recesses 25 for receiving ribs 36 of the retainer 30 to be described later. The housing 20 has first facing surfaces 26 facing the terminals 11 from below, out of surfaces constituting the cavities 22. The recess 25 is recessed downward from the first facing surface 26. As shown in FIG. 10, the recess 25 is open forward.

As shown in FIGS. 1 and 5, the housing 20 is provided with temporary locking portions 27 and complete locking portions 28 projecting from both left and right side surfaces of the housing body 21. The temporary locking portion 27 is disposed forward of the complete locking portion 28. The temporary locking portion 27 is disposed above the complete locking portion 28.

### (Retainer 30)

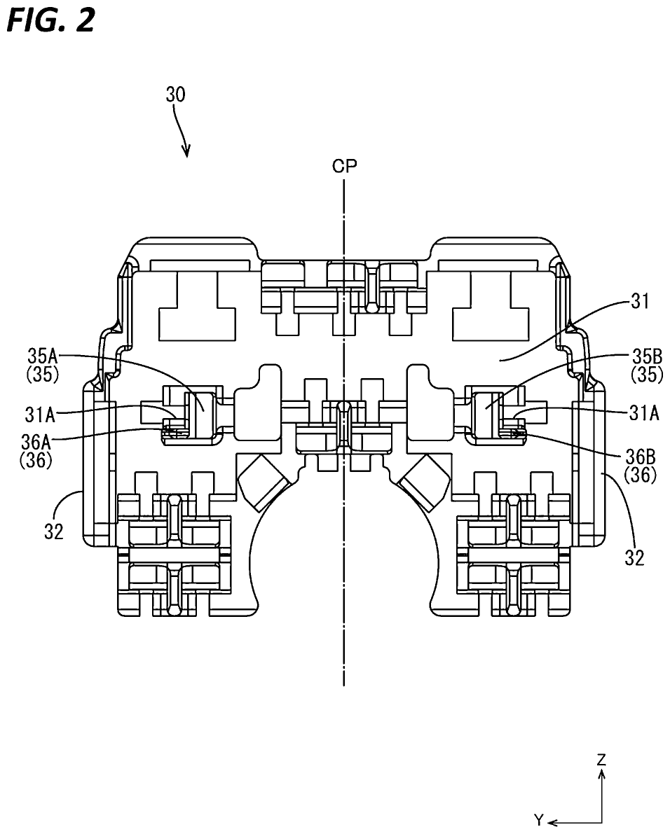

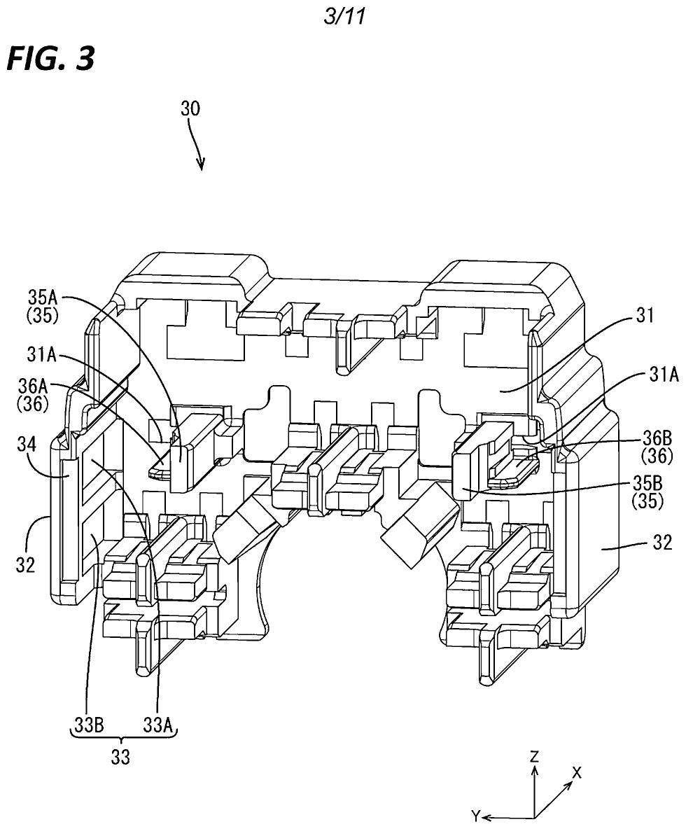

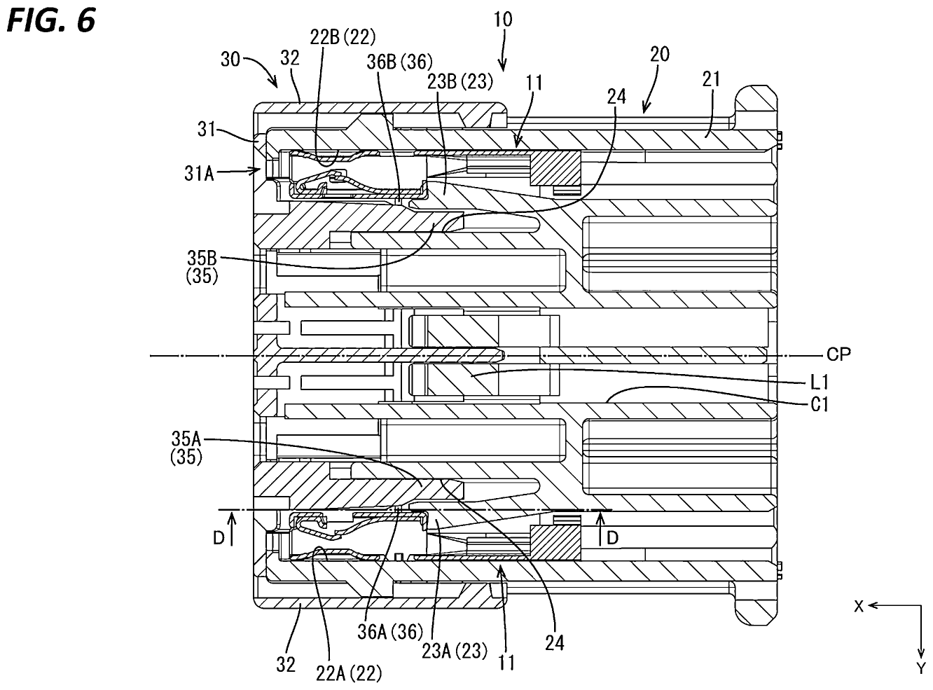

As shown in FIGS. 2 and 3, the retainer 30 is provided with a base wall 31, two lock pieces 32, two restricting portions 35 and two ribs 36. The base wall 31 is in the form of a plate thin in the front-rear direction. The retainer 30 is provided with through holes 31A penetrating through the base wall 31 in the front-rear direction. As shown in FIG. 6, the through holes 31A are disposed at positions communicating with the cavities 22 of the housing 20.

As shown in FIGS. 2 and 3, the two lock pieces 32 extend rearward from left and right end parts of the base wall 31. The lock piece 32 is in the form of a plate thin in the lateral direction. Here, as shown in FIG. 2, a plane disposed in a center between the two lock pieces 32 in the lateral direction is defined as the center plane CP. The center plane CP is a plane orthogonal to the lateral direction. As shown in FIG. 3, the lock piece 32 is formed with locking grooves 33 recessed from a side surface of the lock piece 32 near the center plane CP. Two upper and lower locking grooves 33 are formed to extend in the front-rear direction. The locking grooves 33 include a first locking groove 33A and a second locking groove 33B disposed below the first locking groove 33A. A locking protrusion 34 extending in a direction toward the center plane CP in the lateral direction from the bottom surfaces of the locking grooves 33 is formed on the rear ends of the locking grooves 33.

The lock piece 32 is resiliently deformable in the lateral direction. When the retainer 30 is assembled with the housing 20, the two lock pieces 32 are respectively disposed outside the left and right side surfaces of the housing body 21 and the retainer 30 is pushed rearward. As the retainer 30 is pushed rearward, the temporary locking portions 27 and the locking protrusions 34 are engaged and the two lock pieces 32 are resiliently deformed away from the center plane CP in the lateral direction. If the retainer 30 is pushed further rearward, the locking protrusions 34 ride over the temporary locking portions 27 and the temporary locking portions 27 enter the first locking grooves 33A. Then, the lock pieces 32 return to a natural state and the locking protrusions 34 are disposed between the temporary locking portions 27 and the complete locking portions 28 (see FIG. 5). The position of the retainer 30 shown in FIG. 5 is a temporary locking position. The locking protrusions 34 are locked to the rear surfaces of the temporary locking portions 27. The locking protrusions 34 are locked to the front surfaces of the complete locking portions 28. Thus, the retainer 30 is locked to the housing 20 in the front-rear direction and held at the temporary locking position.

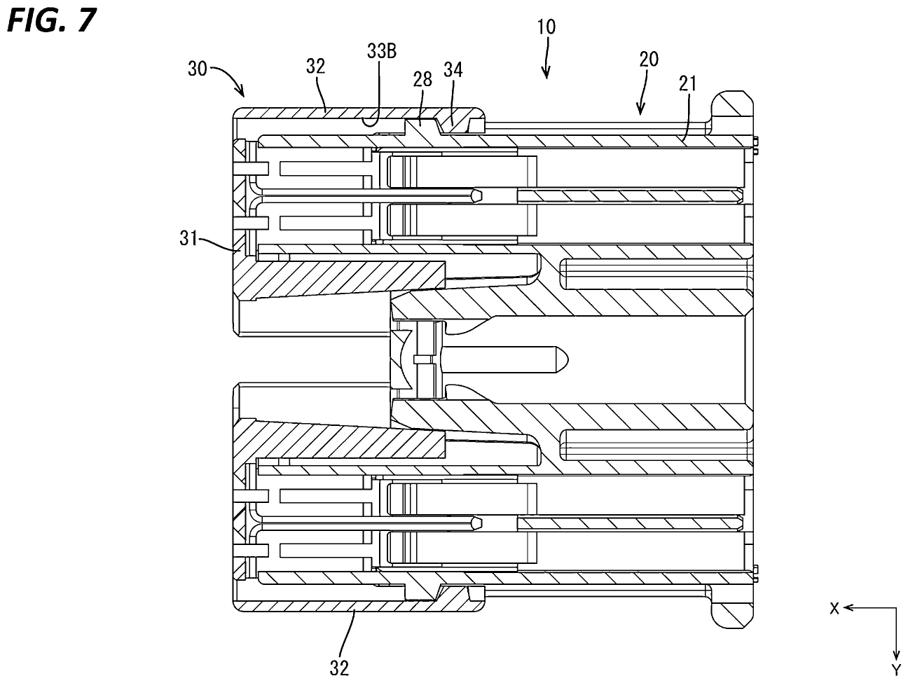

If the retainer 30 is pushed further rearward from the temporary locking position, the complete locking portions 28 and the locking protrusions 34 are engaged and the two lock pieces 32 are resiliently deformed away from the center plane CP in the lateral direction. If the retainer 30 is pushed further rearward, the locking protrusions 34 ride over the complete locking portions 28 and the complete locking portions 28 enter the second locking grooves 33B. Then, the lock pieces 32 return to the natural state and the locking protrusions 34 are disposed in front of the complete locking portions 28 (see FIG. 7). The position of the retainer 30 shown in FIGS. 6 and 7 is a complete locking position. As shown in FIG. 7, the locking protrusion 34 is locked to the rear surface of the complete locking portion 28. Further, the base wall 31 is locked to the front surface of the housing body 21. Therefore, the retainer 30 is locked to the housing 20 in the front-rear direction and held at the complete locking position.

As shown in FIG. 2, the restricting portion 35 is disposed at a position closer to the center plane CP than the through hole 31A. The restricting portion 35 extends rearward from the base wall 31. As shown in FIG. 5, if the retainer 30 is at the temporary locking position, the restricting portions 35 are disposed in front of the deflection spaces 24. The restricting portions 35 are not located in the deflection spaces 24. Thus, the locking lances 23 can be resiliently deformed in the directions toward the center plane CP in the lateral direction and enter the deflection spaces 24. Therefore, the insertion of the terminals 11 into the cavities 22 is allowed.

On the other hand, as shown in FIG. 6, the restricting portions 35 are located in the deflection spaces 24 when the retainer 30 is at the complete locking position. With the restricting portion 35 disposed in the deflection space 24, the locking lance 23 interferes with the restricting portion 35, wherefore the resilient deformation of the locking lance 23 is restricted. That is, the terminal 11 is secondarily locked by the retainer 30. Therefore, the terminal 11 disposed at a proper position in the cavity 22 is suppressed from coming out rearward from the inside of the cavity 22.

The two restricting portions 35 are specifically a first restricting portion 35A and a second restricting portion 35B. The first restricting portion 35A is disposed to the left of the center plane CP. The second restricting portion 35B is disposed to the right of the center plane CP. When the retainer 30 is at the complete locking position, the first restricting portion 35A is in the deflection space 24 for the first locking lance 23A and the second restricting portion 35B is in the deflection space 24 for the second locking lance 23B. Note that, as shown in FIG. 5, the retainer 30 may be provided with restricting portions R1 (e.g. restricting portions R1 for restricting the resilient deformation of the locking lances L1) different from the restricting portions 35.

As shown in FIGS. 2 and 3, the ribs 36 extend from the restricting portions 35. In this embodiment, the ribs 36 extend from the restricting portions 35 in directions away from the center plane CP in the lateral direction. Further, the ribs 36 may extend rearward from the base wall 31. The rib 36 extending from the first restricting portion 35A is a first rib 36A. The rib 36 extending from the second restricting portion 35B is a second rib 36B.

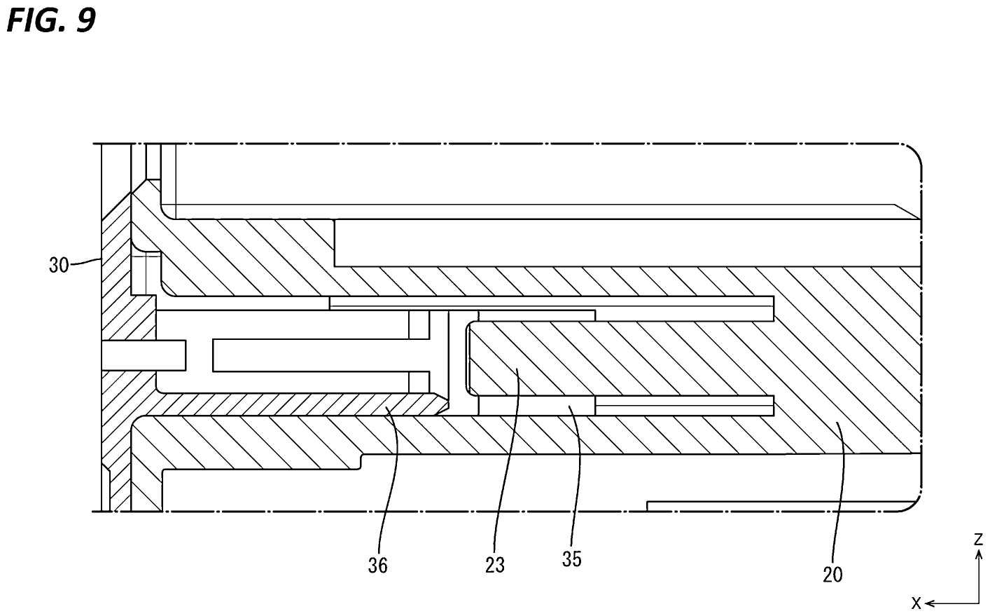

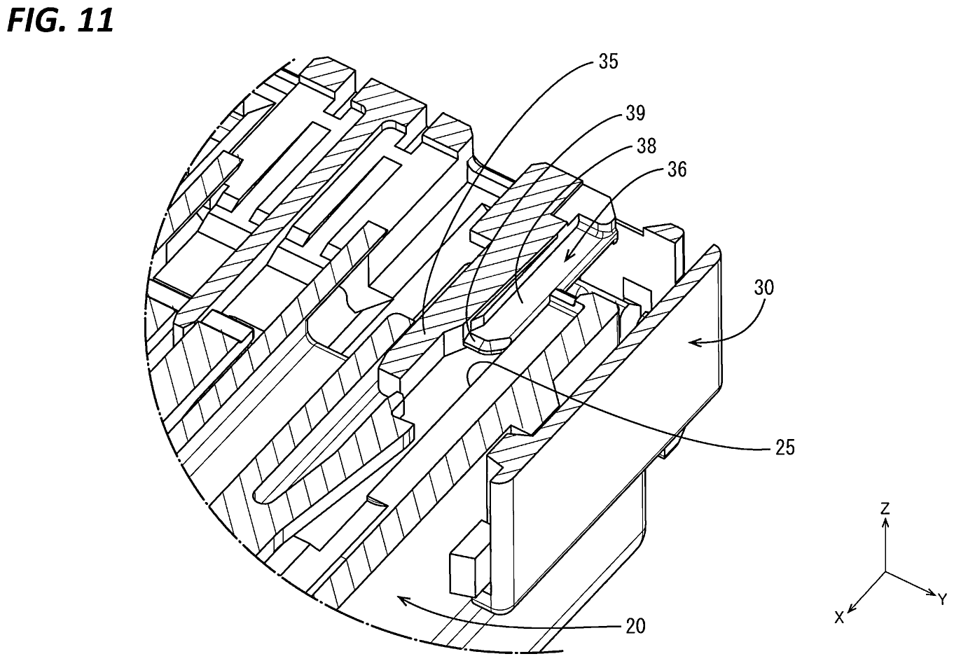

As shown in FIGS. 8 and 11, when the retainer 30 is at the temporary locking position, the rib 36 is disposed in the recess 25. As shown in FIG. 8, the recess 25 has a contact surface 25A facing the rib 36 in the lateral direction. The rib 36 is disposed at a position proximate to the contact surface 25A and closer to the center plane CP than the contact surface 25A in the lateral direction. Note that the rib 36 is disposed in the recess 25 and facing the contact surface 25A in the lateral direction also when the retainer 30 is at the complete locking position and while the retainer 30 is moving from the temporary locking position to the complete locking position. As shown in FIGS. 6 and 9, the rib 36 is provided at a position not in contact with the locking lance 23 when the retainer 30 is at the complete locking position.

In the process of moving the retainer 30 from the temporary locking position (see FIG. 5) to the complete locking position (see FIG. 6), the lock pieces 32 are resiliently deformed away from the center plane CP in the lateral direction. Here, since the restricting portions 35 are connected to the lock pieces 32 via the base wall 31, tip parts of the restricting portions 35 are thought to be displaced away from the center plane CP with respect to base end parts to follow the resilient deformation of the lock pieces 32. Particularly, if the retainer 30 is moved by pressing only a lateral central part of the base wall 31 rearward with fingers or the like, both left and right end parts of the base wall 31 are deformed to warp with respect to the lateral central part, whereby the restricting portions 35 are thought to be easily displaced away from the center plane CP. If such displacements of the restricting portions 35 occur, the restricting portions 35 are thought to contact the locking lances 23 in the front-rear direction and hinder a movement of the retainer 30 to the complete locking position. However, in this embodiment, the ribs 36 contact the contact surfaces 25A, thereby restricting displacements of the restricting portions 35 away from the center plane CP. Thus, the interference of the restricting portions 35 and the locking lances 23 can be suppressed when the retainer 30 is moved from the temporary locking position to the complete locking position. Therefore, the retainer 30 can be brought to the complete locking position.

As shown in FIG. 9, the rib 36 may have a part facing the locking lance 23 in the front-rear direction. According to this configuration, the strength of the rib 36 can be improved by increasing a volume of the rib 36 while the enlargement of a space for arranging the rib 36 in the housing 20 is avoided. In this way, a displacement of the restricting portion 35 away from the center plane CP can be further suppressed.

As shown in FIG. 10, a guide portion 37 is formed on a rear end part of the rib 36. The guide portion 37 is disposed on an extending end part of the rib 36 from the restricting portions 35. The guide portion 37 is inclined to approach the center plane CP in the lateral direction toward a rear side. By providing the guide portion 37, the rib 36 more easily enters the recess 25.

As shown in FIGS. 8 and 5, the restricting portion 35 and the rib 36 form the cavity 22 together with the housing 20 in a region forward of the locking lance 23. As shown in FIG. 8, the rib 36 has a first surface 38 constituting the cavity 22. The first surface 38 is facing the terminal 11 from below. The first surface 38 is disposed substantially at the same height as the first facing surface 26. As shown in FIG. 11, an inclined portion 39 continuous with the first surface 38 is formed on a rear end part of the rib 36. The inclined portion 39 is inclined downward toward the rear side. By providing the inclined portion 39, the interference of the front end of the terminal 11 and the rear end of the rib 36 in the front-rear direction can be suppressed in the process of inserting the terminal 11 into the cavity 22.

### (Functions and Effects of Embodiment)

(1) The connector 10 according to the embodiment is provided with the housing 20 including the cavities 22 extending in the first direction (front-rear direction), the terminals 11 to be disposed in the cavities 22 and the retainer 30 to be assembled with the housing 20 movably in the first direction between the temporary locking position and the complete locking position. The housing 20 is formed with the locking lances 23 disposed in the cavities 22 and resiliently deformable in the second direction (lateral direction) orthogonal to the first direction. The retainer 30 includes the two lock pieces 32 to be locked to the housing 20, the restricting portions 35 for allowing the insertion of the terminals 11 into the cavities 22 when the retainer 30 is at the temporary locking position and interfering with the locking lances 23 to retain the terminals 11 in the cavities 22 when the retainer 30 is at the complete locking position, and the ribs 36 extending from the restricting portions 35. The plane disposed in the center between the two lock pieces 32 in the second direction is the center plane CP. The restricting portions 35 are disposed at the positions deviated in the second direction from the center plane CP. The locking lance 23 interferes with the terminal 11 and is resiliently deformed toward the center plane CP in the second direction in the process of inserting the terminal 11 into the cavity 22. The two lock pieces 32 interfere with the housing 20 and are resiliently deformed away from the center plane CP in the second direction in the process of moving the retainer 30 from the temporary locking position to the complete locking position. The ribs 36 contact the housing 20 to suppress displacements of the restricting portions 35 away from the center plane CP in the second direction in the process of moving the retainer 30 from the temporary locking position to the complete locking position.

According to this configuration, even if the lock pieces 32 are resiliently deformed away from the center plane CP in the second direction in the process of moving the retainer 30 from the temporary locking position to the complete locking position, the ribs 36 contact the housing 20, thereby being able to suppress displacements of the restricting portions 35 away from the center plane CP in the second direction. Therefore, the interference of the restricting portions 35 and the locking lances 23 can be avoided and the retainer 30 can be moved to the complete locking position.
(2) In the embodiment, the restricting portions 35 include the first restricting portion 35A and the second restricting portion 35B disposed on the side opposite to the first restricting portion 35A with respect to the center plane CP. The ribs 36 include the first rib 36A extending from the first restricting portion 35A and the second rib 36B extending from the second restricting portion 35B. The cavities 22 include the first cavity 22A corresponding to the first restricting portion 35A and the second cavity 22B corresponding to the second restricting portion 35B. The locking lances 23 include the first locking lance 23A to be disposed in the first cavity 22A and the second locking lance 23B to be disposed in the second cavity 22B.
(3) In the embodiment, the rib 36 is disposed at a position overlapping the locking lance 23 when viewed from the first direction (in a front view).

According to this configuration, the strength of the rib 36 can be improved while the enlargement of the space for arranging the rib 36 in the housing 20 is avoided.
(4) In the embodiment, the housing 20 is provided with the recesses 25 open toward one side in the first direction (forward) and configured to receive the ribs 36. The rib 36 includes the guide portion 37 disposed on an end part on the other side in the first direction (rear side), and the guide portion 37 is inclined to approach the center plane CP in the second direction toward the other side in the first direction.

According to this configuration, the entrance of the rib 36 into the recess 25 can be guided by the guide portion 37.
(5) In the embodiment, the housing 20 is provided with the recesses 25 open toward the one side in the first direction and configured to receive the ribs 36. The terminal 11 is inserted into the cavity 22 from the other side in the first direction. The rib 36 includes the first surface 38 constituting the cavity 22 together with the housing 20 and the inclined portion 39 continuous with the first surface 38 and disposed on the end part of the rib 36 on the other side in the first direction. The first surface 38 is facing the terminal 11 from one side in the third direction orthogonal to both the first and second directions (from below). The inclined portion 39 is inclined to be located more on the one side in the third direction toward the other side in the first direction.

According to this configuration, the interference of the rib 36 and the terminal 11 can be suppressed by the inclined portion 39.

### (Other Embodiments)

The above embodiment can be modified and carried out as follows. The above embodiment and the following modifications can be carried out in combination without technically contradicting each other.
Although the connector 10 is provided with two cavities 22, two locking lances 23, two restricting portions 35 and two ribs 36 in the above embodiment, a connector of the present disclosure may be provided with one, three or more cavities, one, three or more locking lances, one, three or more restricting portions and one, three or more ribs.
Although the terminal 11 is a female terminal in the above embodiment, a terminal of the present disclosure may be a male terminal.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing including a cavity extending in a first direction;
a terminal to be disposed in the cavity; and
a retainer to be assembled with the housing movably in the first direction between a temporary locking position and a complete locking position,
the housing being formed with a locking lance disposed in the cavity and resiliently deformable in a second direction orthogonal to the first direction,
the retainer including two lock pieces to be locked to the housing, a restricting portion for allowing insertion of the terminal into the cavity when the retainer is at the temporary locking position and interfering with the locking lance to retain the terminal in the cavity when the retainer is at the complete locking position and a rib extending from the restricting portion,
a plane disposed in a center between the two lock pieces in the second direction being a center plane,
the restricting portion being disposed at a position deviated in the second direction from the center plane,
the locking lance interfering with the terminal and being resiliently deformed toward the center plane in the second direction in the process of inserting the terminal into the cavity,
the two lock pieces interfering with the housing and being resiliently deformed away from the center plane in the second direction in the process of moving the retainer from the temporary locking position to the complete locking position, and
the rib suppressing the restricting portion from being displaced away from the center plane in the second direction by contacting the housing in the process of moving the retainer from the temporary locking position to the complete locking position.

2. The connector of claim 1, wherein:
the restricting portions include a first restricting portion and a second restricting portion disposed on a side opposite to the first restricting portion with respect to the center plane,
the ribs include a first rib extending from the first restricting portion and a second rib extending from the second restricting portion,
the cavities include a first cavity corresponding to the first restricting portion and a second cavity corresponding to the second restricting portion, and
the locking lances include a first locking lance disposed in the first cavity and a second locking lance disposed in the second cavity.

3. The connector of claim 1, wherein the rib is disposed at a position overlapping the locking lance when viewed from the first direction.

4. The connector of claim 1, wherein:
the housing includes a recess open toward one side in the first direction and configured to receive the rib,
the rib includes a guide portion disposed on an end part on the other side in the first direction, and
the guide portion is inclined to approach the center plane in the second direction toward the other side in the first direction.

5. The connector of claim 1, wherein:
the housing includes a recess open toward one side in the first direction and configured to receive the rib,
the terminal is inserted into the cavity from the other side in the first direction,
the rib includes a first surface constituting the cavity together with the housing and an inclined portion continuous with the first surface and disposed on an end part of the rib on the other side in the first direction,
the first surface is facing the terminal from one side in a third direction orthogonal to both the first and second directions, and
the inclined portion is inclined to be located more on the one side in the third direction toward the other side in the first direction.
